(19) United States
(12) Patent Application Publication
(10) Pub. No.: US 2012/0254493 A1
(43) Pub. Date: Oct. 4, 2012

(54) TRANSVERSE INSERTION TYPE NOTEBOOK COMPUTER DOCKING STATION

(75) Inventor: Jhao-Ming Wang, Taipei City (TW)

(73) Assignee: INVENTEC CORPORATION, Taipei City (TW)

(21) Appl. No.: 13/157,126

(22) Filed: Jun. 9, 2011

(30) Foreign Application Priority Data
Mar. 29, 2011 (TW) 100110775

(51) Int. Cl. G06F 13/14

(52) U.S. Cl. 710/303

(57) ABSTRACT

A transverse insertion type notebook computer docking station for a notebook computer to be transversely inserted is provided. The transverse insertion type notebook computer docking station includes a body having a bottom surface, an inner side surface, a first side surface and a connecting port. The bottom surface, the inner side surface and the first side surface connect to each other, wherein normal directions of the bottom surface, the inner side surface and the first side surface are perpendicular to each other. The connecting port is disposed on the inner side surface. The transverse insertion type notebook computer docking station is used for a notebook computer to insert in, so as to prevent the notebook computer from toppling due to its own weight.

### CROSS-REFERENCE TO RELATED APPLICATION

This application claims the priority benefit of Taiwan application serial no. 100110775, filed on Mar. 29, 2011. The entirety of the above-mentioned patent application is hereby incorporated by reference herein and made a part of specification.

### BACKGROUND OF THE INVENTION

1. Field of the Invention

The invention relates to a notebook computer docking station, and more particularly to a transverse insertion type notebook computer docking station for a notebook computer to be transversely inserted.

2. Description of Related Art

In recent years, the mobility, simplicity, and multifunctional properties of portable computers and notebook computers have provided users an alternative to conventional tabletop computers. Because of notebook computers, many docking devices have been developed to extend the battery life of notebook computers. The docking devices also have other functions, such as a multi-media function. Thus, notebook computers which have become smaller and therefore have a restricted battery life, causing a restriction in the functions of the notebook computers, can be accompanied with a docking device to overcome those problems. Docking equipment, such as an external speaker, an external CD drive, an external battery, or a connecting port, will usually be combined to form a docking station.

Currently, docking stations can be divided to two types. One type is U-shaped as shown in FIG. 10A, and another type is a vertical insertion type docking station shown in FIG. 10B. Using the U-shaped docking station as an example, because the shapes of different notebook computers vary, specific sized docking stations are required. Also, after a notebook computer is inserted in the docking station, the host of the notebook computer is still placed on the table, taking up space. The other vertical insertion type docking station takes up less space, but if the notebook computer is big (the taller the computer, the heavier), when the notebook computer is inserted vertically into the docking station, the notebook is prone to topple from its own weight. Also, it is difficult for the user to insert and pull out the notebook computer vertically.

### SUMMARY OF THE INVENTION

The invention is directed to a transverse insertion type notebook computer docking station for a notebook computer to be transversely inserted. Notebook computers with varied sizes can be transversely inserted into the transverse insertion type notebook computer docking station.

In order to achieve the aforementioned and other objects, the invention provides a transverse insertion type notebook computer docking station for a notebook computer to be transversely inserted. The transverse insertion type notebook computer docking station includes a body, wherein the body has a bottom support surface, an inner side surface, a first side surface, and a connecting port. The bottom support surface, the inner side surface, and the first side surface connect to each other, and normal directions of the bottom support surface, the inner side surface, and the first side surface are perpendicular to each other. The connecting port is disposed on the inner side surface.

In an embodiment of the transverse insertion type notebook computer docking station of the invention, the body further includes a bottom surface separated from the bottom support surface by a distance. The extensions of the bottom support surface and the first side surface respectively form an acute angle with the bottom surface. In addition, the body further includes an inclined surface. The inclined surface, the bottom surface, and the first side surface form a triangular structure, and a center of gravity of the body is in the triangular structure.

In an embodiment of the transverse insertion type notebook computer docking station of the invention, the body further includes a second side surface facing the first side surface. The second side surface is connected to the inner side surface and the bottom support surface, and the first side surface and the second side surface are located on the opposite sides of the inner side surface and the bottom support surface. In addition, the transverse insertion type notebook computer docking station further includes a pair of positioning elastic pieces disposed on the bottom support surface and used to clasp the notebook computer. Alternately, the transverse insertion type notebook computer docking station further includes a positioning sliding piece. The bottom support surface includes a pair of sliding tracks, and the positioning sliding piece is slidably disposed on the pair of sliding tracks. Thus, the notebook computer is adapted to rest on the sliding piece so that the notebook computer moves relative to the inner side surface through the positioning sliding piece and the sliding tracks. The positioning sliding piece can further include a pair of holding portions, used to clasp the notebook computer.

In an embodiment of the transverse insertion type notebook computer docking station of the invention, a pair of side wings are further disposed on the two opposite sides of the body.

In an embodiment of the transverse insertion type notebook computer docking station of the invention, the embodiment further includes a plurality of wheels, disposed parallel to each other on the body. A portion of the wheels are exposed to serve as a portion of the bottom support surface, and an axis of the wheels are perpendicular to a direction the notebook computer is inserted.

In an embodiment of the transverse insertion type notebook computer docking station of the invention, the embodiment further includes a pair of wheels, disposed on the body, and the bottom support surface is a surface of a belt disposed on the wheels.

Based on the above, the transverse insertion type notebook computer docking station of the invention is for a notebook to be transversely inserted. This way, not only is there more space on a table, since the notebook computer is transversely inserted, the problem of a bigger and heavier notebook computer falling over because of an unstable center of gravity when it is vertically inserted can be avoided.

In order to make the aforementioned and other features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic view illustrating a notebook computer transversely inserted into a transverse insertion type notebook computer docking station of a first embodiment of the invention.

FIG. 2 is a schematic view of the transverse insertion type notebook computer docking station in FIG. 1 from another perspective.

FIG. 3 is a schematic view of a transverse insertion type notebook computer docking station of a second embodiment of the invention.

FIG. 4 is a schematic view of a transverse insertion type notebook computer docking station of a third embodiment of the invention.

FIG. 5 is a schematic view of a transverse insertion type notebook computer docking station of a fourth embodiment of the invention.

FIG. 6 is a schematic view of a transverse insertion type notebook computer docking station of a fifth embodiment of the invention.

FIG. 7 is a schematic view of a transverse insertion type notebook computer docking station of a sixth embodiment of the invention.

FIG. 8 is a schematic view of a transverse insertion type notebook computer docking station of a seventh embodiment of the invention.

FIG. 9 is a schematic view of a transverse insertion type notebook computer docking station of an eighth embodiment of the invention.

FIG. 10A is a schematic view of a conventional U-shaped docking station.

FIG. 10B is a schematic view of a conventional vertical insertion type docking station.

### DESCRIPTION OF EMBODIMENTS

### First Embodiment

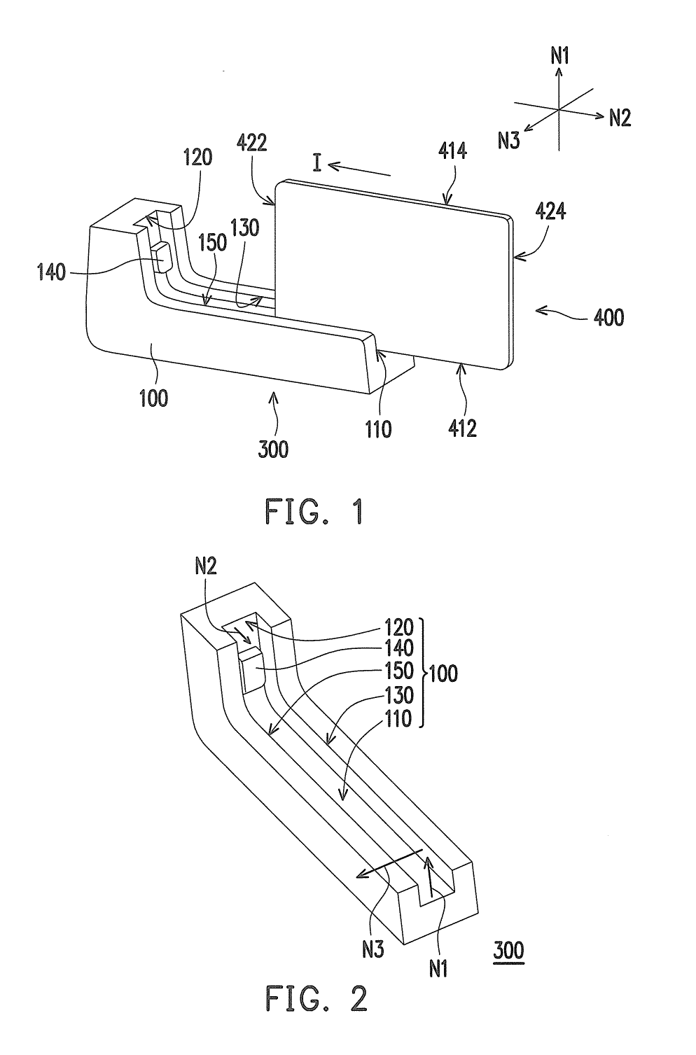

FIG. 1 is a schematic view illustrating a notebook computer transversely inserted into a transverse insertion type notebook computer docking station of a first embodiment of the invention. FIG. 2 is a schematic view of the transverse insertion type notebook computer docking station in FIG. 1 from another perspective. Referring to FIG. 1 and FIG. 2, a transverse insertion type notebook computer docking station 300 is for a notebook computer 400 to be transversely inserted. In detail, the transverse insertion type notebook computer docking station 300 includes a body 100, wherein the body 100 has a bottom support surface 110, an inner side surface 120, a first side surface 130, and a connecting port 140. The bottom support surface 110, the inner side surface 120, and the first side surface 130 connect to each other, and normal directions N1, N2, N3 of the bottom support surface 110, the inner side surface 120, and the first side surface 130, respectively, are perpendicular to each other. The connecting port 140 is disposed on the inner side surface 120.

In further detail, the body 100 further includes a second side surface 150 facing the first side surface 130. The second side surface 150 is connected to the inner side surface 120 and the bottom support surface 110, and the first side surface 130 and the second side surface 150 are located on opposite sides of the inner side surface 120 and the bottom support surface 110. Thus, the bottom support surface 110, the inner side surface 120, the first side surface 130, and the second side surface 150 form a slot (not shown) for the notebook computer 400 to be inserted. The top and right side (shown in FIG. 1) of the slot (not shown) is open. The notebook computer 400 can be transversely inserted into the body 100 of the transverse insertion type notebook computer docking station 300 along the right side of the slot (not shown) towards the inner side surface 120.

Specifically, the notebook computer 400 includes a pair of long edges 412 and 414, a pair of short edges 422 and 424, and a second connecting port (not shown). The second connecting port (not shown) is disposed on the short edge 422. When the notebook computer 400 is transversely inserted into the body 100 of the transverse insertion type notebook computer docking station 300 along the right side of the slot (not shown) towards the inner side surface 120, the long edge 412 of the notebook computer 400 rests and moves on the bottom support surface 110, and the second connecting port disposed on the short edge 422 faces the inner side. When the first connecting port 140 of the body 100 connects with the second connecting port, the notebook computer 400 and the transverse insertion type notebook computer docking station 300 are electrically connected, expanding the functions of the notebook computer 400.

Contrary to a conventional U-shaped docking station, the body of the notebook computer will take up space on the table. The transverse insertion type notebook computer docking station 300 allows the notebook computer 400 to be transversely inserted. Thus, less table space is required. In addition, since the notebook computer 400 is transversely inserted into the transverse insertion type notebook computer docking station 300, the notebook computer 400 has a low center of gravity, and is closer to the table. Therefore, the problem of a bigger and heavier notebook computer 400 falling over because of an unstable center of gravity when it is vertically inserted can be avoided. Since the long edge 412 of the notebook computer 400 rests and moves horizontally on the bottom support surface 110, the user does not have to hold the entire notebook computer 400, thus saving effort.

### Second Embodiment

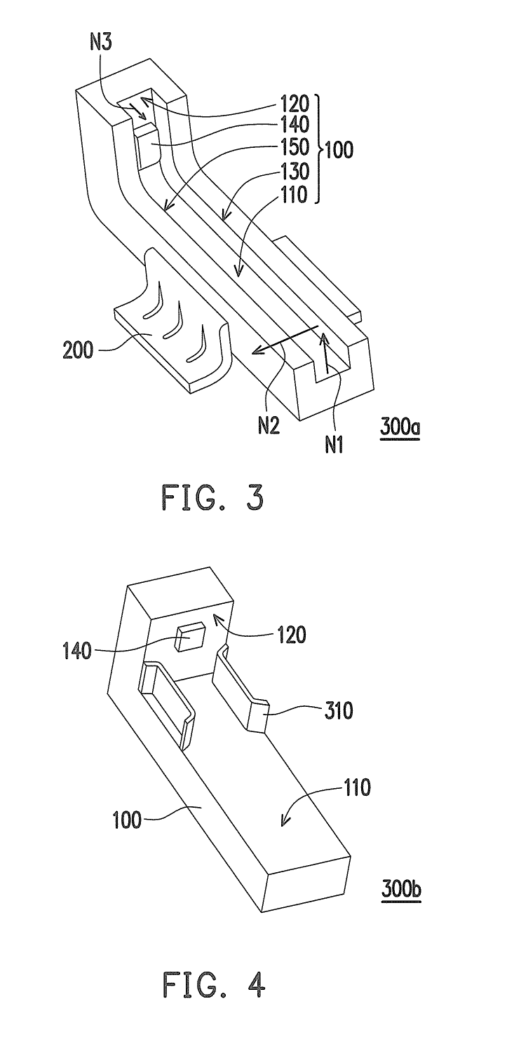

FIG. 3 is a schematic view of a transverse insertion type notebook computer docking station of a second embodiment of the invention. The embodiment is approximately identical to the first embodiment, and same or similar reference numerals used in the embodiment and in the first embodiment represent the same or similar elements. The difference is that in the embodiment, a transverse insertion type notebook computer docking station 300a further includes a pair of side wings 200 disposed on opposite sides of the body 100. Please refer to FIG. 1 and FIG. 3. In order to increase the stability of the notebook computer 400 transversely inserted into the transverse insertion type notebook computer docking station 300a on a table, the transverse insertion type notebook computer docking station 300a further includes a pair of side wings 200 disposed on the two opposite sides of the body 100. Thus, the notebook computer 400 will not fall over when it is bumped or being inserted into the transverse insertion type notebook computer docking station 300a.

The following descriptions are improvements to facilitate the flow of inserting the notebook computer into the transverse insertion type notebook computer docking station or to provide stability to the transverse insertion type notebook computer docking station. In order to clearly describe the improvements, the following figures do not show the first side surface and the second side surface, and only shows the bottom support surface, the inner side surface, and the components or structures disposed on the bottom support surface.

### Third Embodiment

FIG. 4 is a schematic view of a transverse insertion type notebook computer docking station of a third embodiment of the invention. Referring to FIG. 1 and FIG. 4, the embodiment is approximately identical to the first embodiment. The difference is, in the embodiment, a transverse insertion type notebook computer docking station 300b further includes a pair of positioning elastic pieces 310 disposed on the bottom support surface 110 of the body 100, used to clasp the notebook computer 400. Referring to FIG. 1 and FIG. 4, the pair of positioning elastic pieces 310 of the embodiment is disposed on the bottom support surface 110 near the inner side surface 120. However, the pair of positioning elastic pieces 310 can be disposed in any location on the bottom support surface 110 according to need. The pair of positioning elastic pieces 310 are disposed so that when the notebook computer 400 is transversely inserted into the transverse insertion type notebook computer docking station 300b, it clasps the notebook computer 400, allowing the first connecting port 140 and the second connecting port (not shown) to align with more precision, and increase the stability between the notebook computer 400 and the transverse insertion type notebook computer docking station 300b.

### Fourth Embodiment

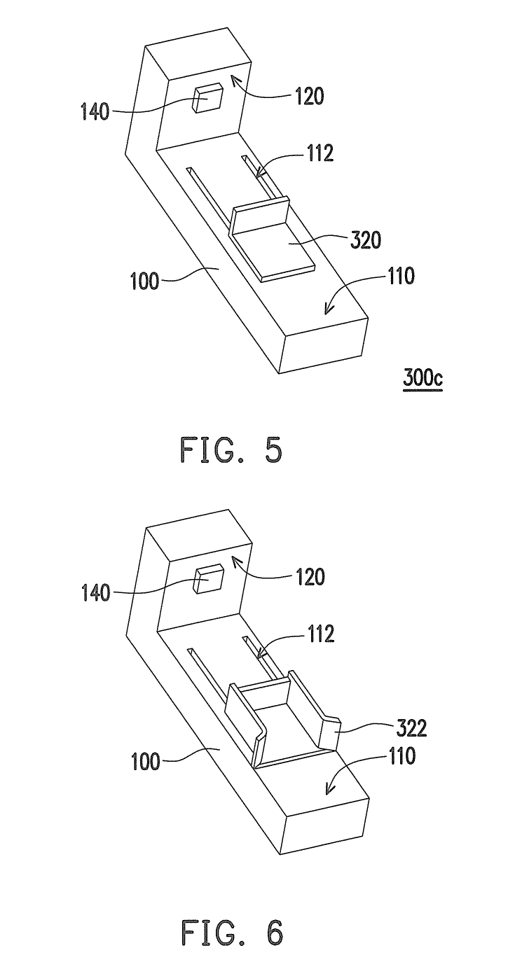

FIG. 5 is a schematic view of a transverse insertion type notebook computer docking station of a fourth embodiment of the invention. Referring to FIG. 1 and FIG. 5, the embodiment is approximately identical to the first embodiment. The difference is, in the embodiment, a transverse insertion type notebook computer docking station 300c further includes a positioning sliding piece 320. The bottom support surface 110 includes a pair of sliding tracks 112, and the positioning sliding piece 320 is slidably disposed on the pair of sliding tracks 112. Referring to FIG. 1 and FIG. 5, the sliding tracks 112 and the positioning sliding piece 320 are disposed so that the notebook computer 400 is adapted to rest on the sliding piece. This way, the notebook computer 400 moves relative to the inner side surface 120 through the positioning sliding piece 320 and the sliding tracks 112 and is inserted in the transverse insertion type notebook computer docking station 300c.

### Fifth Embodiment

FIG. 6 is a schematic view of a transverse insertion type notebook computer docking station of a fifth embodiment of the invention. The embodiment is approximately identical to the fourth embodiment. The difference is, in the embodiment, a pair of holding portions 322 is disposed on the positioning sliding piece 320 away from the inner side surface 120, used to clasp the notebook computer 400.

### Sixth Embodiment

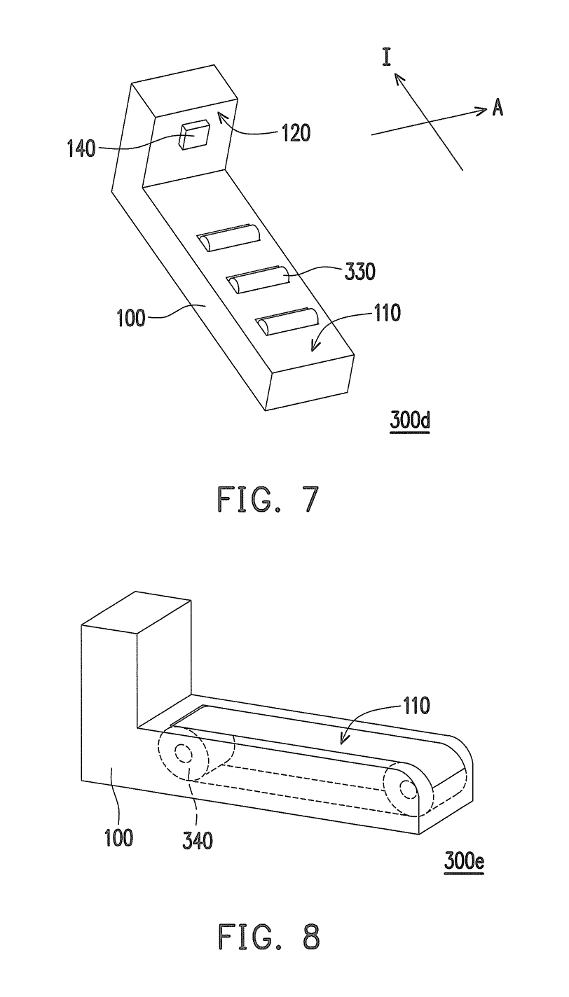

FIG. 7 is a schematic view of a transverse insertion type notebook computer docking station of a sixth embodiment of the invention. Referring to FIG. 1 and FIG. 7, the embodiment is approximately identical to the first embodiment. The difference is, in the embodiment, a transverse insertion type notebook computer docking station 300d further includes a plurality of wheels 330, disposed parallel to each other on the body 100. A portion of the wheels 330 are exposed to serve as the bottom support surface 110, and an axis A of the wheels 330 are perpendicular to a direction I the notebook computer 400 is inserted.

The wheels 330 are disposed so that after the notebook computer 400 is inserted into the transverse insertion type notebook computer docking station 300d along the direction I, when the long edge 412 of the notebook computer 400 contacts the wheels 330, the wheels 330 rotate to facilitate the insertion movement of the notebook computer 400, thereby saving energy.

### Seventh Embodiment

FIG. 8 is a schematic view of a transverse insertion type notebook computer docking station of a seventh embodiment of the invention. Referring to FIG. 1 and FIG. 8, the embodiment is approximately identical to the sixth embodiment. The difference is, in the embodiment, a transverse insertion type notebook computer docking station 300e includes a pair of wheels 340 disposed in the body 100, and the bottom support surface 110 is a surface of a belt disposed on the wheels 340. The wheels 340 and the belt form a transfer mechanism. Compared to the sixth embodiment, after the notebook computer 400 contacts the belt surface (bottom support surface 110), the belt drives the wheels 340 to rotate, and the wheels 340 in turn rotate to move the belt. Thus, the notebook computer 400 is transversely inserted into the transverse insertion type notebook computer docking station 300e.

### Eighth Embodiment

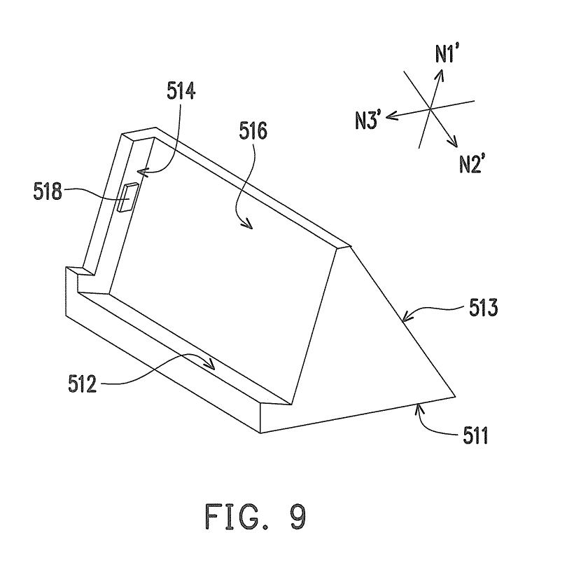

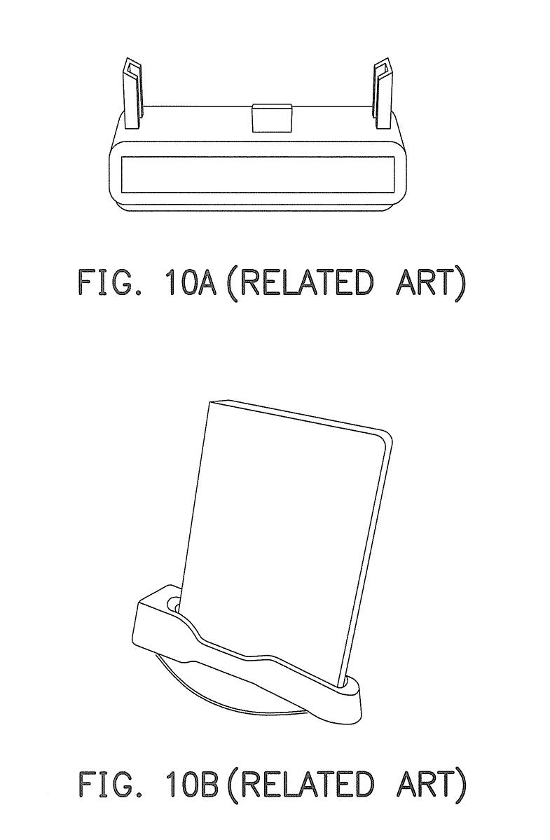

FIG. 9 is a schematic view of a transverse insertion type notebook computer docking station of an eighth embodiment of the invention. Referring to FIG. 9, a body 510 of a transverse insertion type notebook computer docking station 500 of the embodiment includes a bottom support surface 512, an inner side surface 514, a first side surface 516, a first connecting port 518, and a bottom surface 511. The bottom surface 511 is suitable to rest on the table, and is separated from the bottom support surface 512 by a distance. The bottom surface 511 is not parallel or perpendicular to the bottom support surface 512. The bottom support surface 512, the inner side surface 514, and the first side surface 516 are connected. The normal directions N1′, N2′, and N3′ of the bottom support surface 512, the inner side surface 514, and the first side surface 516, respectively, are perpendicular to each other. In addition, the extensions of the bottom support surface 512 and the first side surface 516 respectively form an acute angle with the bottom surface 511. Furthermore, the body further includes an inclined surface 513. The inclined surface 513, the bottom surface 511, and the first side surface 516 form a triangular structure, and a center of gravity of the body 510 is in the triangular structure.

Referring to FIG. 1 and FIG. 9, when the user transversely inserts the notebook computer 400 into the transverse insertion type notebook computer docking station 500, the bottom surface (not shown) of the notebook computer 400 leans on the first side surface 516. Then, the notebook computer 400 moves along the opposite direction of the normal direction N2′ of the inner side surface 514, so that the second connecting port (not shown) of the notebook computer 400 connects through insertion with the first connecting port 518. Compared to previous embodiments, the transverse insertion type notebook computer docking station 500 of the embodiment does not include a second side surface opposite to the first side surface 516. Therefore, it is easier for the user to assemble the notebook computer 400 with the transverse insertion type notebook computer docking station 500. In addition, the notebook computer 400 is inclined with respect to the table, by using the shape of the transverse insertion type notebook computer docking station 500. This allows the entire assembly to have a lower center of gravity, reducing the chance of falling over.

In summary, the transverse insertion type notebook computer docking station of the invention is for a notebook to be transversely inserted. This way, there is more space on a table, and so a notebook computer that is transversely inserted into the transverse insertion type notebook computer docking station saves more space on a table compared to a conventional tabletop computer. In addition, for a notebook computer that is transversely inserted into the transverse insertion type notebook computer docking station, the problem of a bigger and heavier notebook computer falling over because of an unstable center of gravity can be avoided.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A transverse insertion type notebook computer docking station for a notebook computer to be transversely inserted, the transverse insertion type notebook computer docking station comprising a body, the body having a bottom support surface, an inner side surface, a first side surface, and a connecting port, wherein the bottom support surface, the inner side surface, and the first side surface connect to each other, and normal directions of the bottom support surface, the inner side surface, and the first side surface are perpendicular to each other, and the connecting port is disposed on the inner side surface.

2. The transverse insertion type notebook computer docking station as claimed in claim 1, wherein the body further comprises a bottom surface separated from the bottom support surface by a distance, and the extensions of the bottom support surface and the first side surface respectively form an acute angle with the bottom surface.

3. The transverse insertion type notebook computer docking station as claimed in claim 2, wherein the body further comprises an inclined surface, the inclined surface, the bottom surface, and the first side surface form a triangular structure, and a center of gravity of the body is in the triangular structure.

4. The transverse insertion type notebook computer docking station as claimed in claim 1, wherein the body further comprises a second side surface facing the first side surface, the second side surface is connected to the inner side surface and the bottom support surface, and the first side surface and the second side surface are located on opposite sides of the inner side surface and the bottom support surface.

5. The transverse insertion type notebook computer docking station as claimed in claim 4, further comprising a pair of positioning elastic pieces disposed on the bottom support surface and used to clasp the notebook computer.

6. The transverse insertion type notebook computer docking station as claimed in claim 4, further comprising a positioning sliding piece, wherein the bottom support surface comprises a pair of sliding tracks, the positioning sliding piece is slidably disposed on the pair of sliding tracks, and the notebook computer is adapted to rest on the sliding piece so that the notebook computer moves relative to the inner side surface through the positioning sliding piece and the sliding tracks.

7. The transverse insertion type notebook computer docking station as claimed in claim 6, wherein the positioning sliding piece further comprises a pair of holding portions, used to clasp the notebook computer.

8. The transverse insertion type notebook computer docking station as claimed in claim 1, further comprising a pair of side wings, disposed on opposite sides of the body.

9. The transverse insertion type notebook computer docking station as claimed in claim 1, further comprising a plurality of wheels, disposed parallel to each other on the body, wherein a portion of the wheels are exposed to serve as a portion of the bottom support surface, and an axis of the wheels are perpendicular to a direction which the notebook computer is inserted.

10. The transverse insertion type notebook computer docking station as claimed in claim 1, further comprising a pair of wheels, disposed in the body, and the bottom support surface is a surface of a belt disposed on the wheels.
